(19) United States
(12) Patent Application Publication
(10) Pub. No.: US 2012/0274474 A1
(43) Pub. Date: Nov. 1, 2012

(54) INDICATOR LIGHT CIRCUIT AND ELECTRONIC DEVICE EMPLOYING THE SAME

(75) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/213,096

(22) Filed: Aug. 19, 2011

(30) Foreign Application Priority Data
Apr. 26, 2011 (CN) 201110104981.0

(51) Int. Cl. G08B 21/00

(52) U.S. Cl. 340/687

(57) ABSTRACT

An indicator light circuit includes a network interface card (NIC) microchip, a male connector, a male connector, a connection state indicator, and an operating state indicator. The male connector connects to the female connector to exchange data. The connection state indicator and the operating state indicator are positioned on a keyboard. When the NIC microchip establishes connection with a communication network at a certain data speed, the NIC microchip outputs a first command signal to the connection state indicator; and the connection state indicator is powered on. When the NIC microchip starts and establishes communication with the communication network at another certain data speed, the NIC microchip outputs a second command signal to the operating state indicator through the female connector and the male connector, the operating state indicator is powered on.

### BACKGROUND

1. Technical Field

The disclosure generally relates to control circuits, and more particularly to an indicator light circuit and an electronic device employing the same.

2. Description of the Related Art

Computers, servers, or network hosts usually have three indicators to monitor and inform a status of the network: a network link indicator light, a 10M/100M operating indicator light and a 1000M operating indicator light. These indicator lights are electrically connected to RJ-45 connectors of the network Hosts. However, in assembly, the RJ-45 connectors and the indicator lights are together assembled at the back of the network host, which is makes it very difficult to view and monitor the status of the network.

Therefore, there is room for improvement within the art.

### BRIEF DESCRIPTION OF THE DRAWINGS

Many aspects of an indicator light circuit and electronic device employing the same can be better understood with reference to the following drawings. The components in the drawings are not necessarily drawn to scale, the emphasis instead being placed upon clearly illustrating the principles of the indicator light circuit and electronic device employing the same. Moreover, in the drawings, like reference numerals designate corresponding parts throughout the several views. Wherever possible, the same reference numbers are used throughout the drawings to refer to the same or like elements of an embodiment.

FIG. 1 is a block view of an electronic device, according to an embodiment of the disclosure.

FIG. 2 is a circuit view of an embodiment of the electronic device shown in FIG. 1.

### DETAILED DESCRIPTION

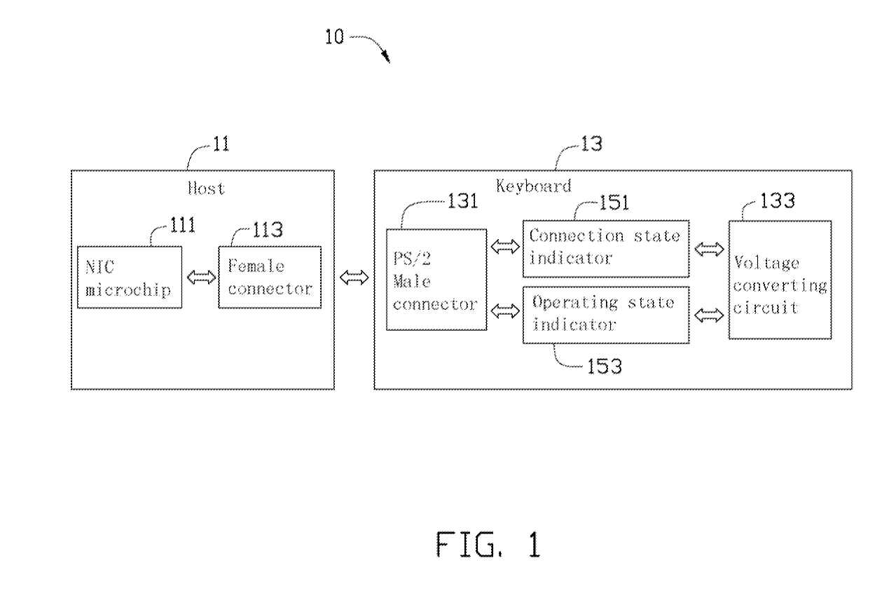

FIG. 1 is a block view of an electronic device 10, according to an embodiment of the disclosure. The electronic device 10 can be a computer and includes a network host 11, a keyboard 13, a connection state indicator 151, and an operating state indicator 153. The network host 11 is in electronic communication with the keyboard 13.

The network host 11 is designed to receive a motherboard and other components of the electronic device 10, such as memory, connectors, hard drives, and power supplies. In this embodiment, the network host 11 includes a network interface card (NIC) microchip 111 and a female connector 113 electrically connected to the NIC microchip 111. The keyboard 13 includes a housing (not shown), a male connector 131 and a voltage converting circuit 133. In this embodiment, the female connector 113 can be a personal system 2 (PS/2) female connector. The male connector 131, positioned in the housing, can be a PS/2 male connector electrically connected to the female connector 113 to carry out and establish communication between the network host 11 and the keyboard 13.

The connection state indicator 151 and the operating state indicator 153 are positioned on the housing of the keyboard 13 and are electrically connected to the male connector 131. In this embodiment, the connection state indicator 151 and the operating state indicator 153 are light emitting diodes.

When the NIC microchip 111 establishes connection with an external local area network (LAN), the NIC microchip 111 provides and outputs a first command signal to the connection state indicator 151 via the female connector 113 and the male connector 131, thus lighting up the connection state indicator 151. When the NIC microchip 111 starts and establishes communication with the LAN, the NIC microchip 111 provides and outputs a second command signal to the operating state indicator 153 through the connectors 113 and 131, enabling the operating state indicator 153 to light up.

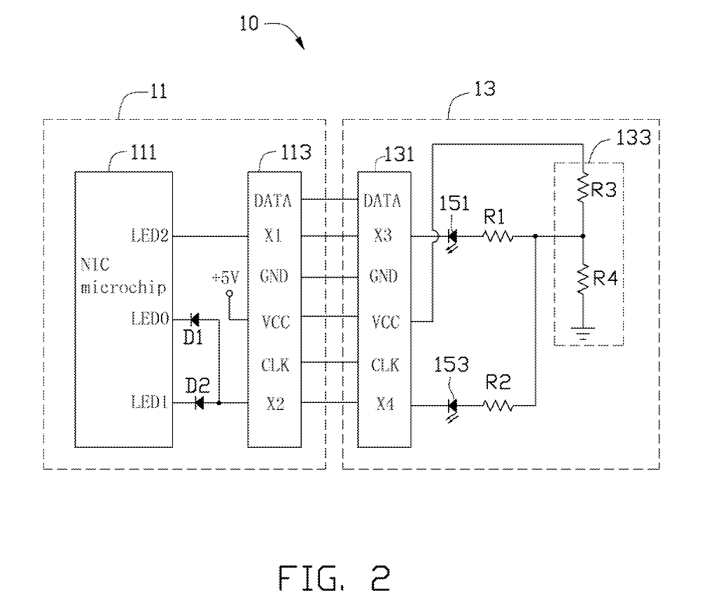

Referring to FIG. 2, the NIC microchip 111 is designed to allow and carry out communication and data transmission between the network host 11 and the LAN. The NIC microchip 111 can be a network adapter. In this embodiment, the NIC microchip 111 includes a first operating state pin LED0, a second operating state pin LED1, and a connection state pin LED2.

In this embodiment, when the connection between the NIC microchip 111 and the LAN is not established, the first operating state pin LED0, the second operating state pin LED1 and the connection state pin LED2 output high voltage signals (e.g., logical 1). When the NIC microchip 111 starts and establishes a connection with the LAN, the connection state pin LED2 outputs a low voltage signal (e.g., logical 0), that is, the first command signal. When the NIC microchip 111 establishes communication with the LAN at a 10M/100M link speed, the first operating pin LED0 outputs a pulse signal, that is, the second command signal. When the NIC microchip 111 is communicating with the LAN using the 1000M link speed, the second operating pin LED1 outputs a pulse signal (e.g., the second command signal).

The female connector 113 includes a data pin DATA, a first pin X1, a group pin GND, a power pin VCC, a clock pin CLK, and a second pin X2. The male connector 131 includes a data pin DATA, a third pin X3, a group pin GND, a power pin VCC, a clock pin CLK, and a fourth pin X4 electrically connected to the data pin DATA, the first pin X1, the group pin GND, a power pin VCC, a clock pin CLK and the second pin X2 respectively of the female connector 113. In this embodiment, the pins of the female connector 113 have substantially the same function as the corresponding pins of the male connector 131.

The power pin VCC of the female connector 113 is electrically connected to a 5V power supply of the network host 11, thereby, the keyboard 13 is powered by the 5V power supply through the power pin VCC of the male connector 131. The power pin VCC of the male connector 131 is electrically connected to the voltage converting circuit 133. The electronic device 10 further includes a first diode D1 and a second diode D2. In this embodiment, the first diode D1 and the second diode D2 are isolation diodes.

In this embodiment, the first pin X1 of the female connector 113 is electrically connected to the connection state pin LED2. The second pin X2 of the female connector 113 is electrically connected to the anodes of the first diode D1 and the second diode D2. The cathode of the first diode D1 is electrically connected to the first operating state pin LED0 of the NIC microchip 111, and the cathode of the second diode D2 is electrically connected to the second operating state pin LED1 of the NIC microchip 111. The third pin X3 of the male connector 131 electrically connects the cathode of the connection state indicator 151. The fourth pin X4 of the male connector 131 is electrically connected to the cathode of the operating state indicator 153. Thus, the first diode D1 and the second diode D2 are configured for respectively preventing any noise from the first operating state pin LED0 and the second operating state pin LED1 from interfering with the operating state indicator 153.

The electronic device 10 further includes a first current limiting resistor R1 and a second current limiting resistor R2. Anode of the connection state indicator 151 is electrically connected to one end of the first current limiting resistor R1 to provide over-current protection for the connection state indicator 151, and the other end of the first current limiting resistor R1 is electrically connected to the voltage converting circuit 133. Anode of the operating state indicator 153 is electrically connected to the second current limiting resistor R2 to protect the operating state indicator 153 from experiencing over-current, and the other end of the second current limiting resistor R2 is electrically connected to the voltage converting circuit 133.

The voltage converting circuit 133 provides appropriate operating voltages for the connection state indicator 151 and the operating state indicator 153. In detail, the voltage converting circuit 133 converts 5V voltage from the power pin VCC of the male connector 131 into a 3.3V operating voltage, providing this voltage for the connection state indicator 151 and the operating state indicator 153. In this embodiment, the voltage converting circuit 133 can be a voltage dividing circuit and includes a first voltage dividing resistor R3 and a second voltage dividing resistor R4 electrically connected to the first voltage dividing resistor R3 in series.

The power pin VCC of the male connector 131 is electrically connected to the first voltage dividing resistor R3, the second voltage dividing resistor R4 is electrically connected to ground. In addition, the current limiting resistors R1 and R2 are electrically connected between the first voltage dividing resistor R3 and the second voltage dividing resistor R4. In this embodiment, the voltage dividing resistors R3 and R4 can be slide rheostats which provide a predetermined operating voltage for the connection state indicator 151 and the operating state indicator 153 by adjustment of their resistances. Moreover, the voltage converting circuit 133 can be a voltage converter, which can convert a 5V input voltage into a 3.3V output voltage.

Also referring to FIGS. 1 and 2, in use, the male connector 131 of the keyboard 13 is electrically connected to the female connector 113 of the network host 11. When the NIC microchip 111 has not yet established a connection with the LAN, the first operating state pin LED0, the second operating state pin LED1 and the connection state pin LED2 output the high voltage signals (e.g., logical 1), so the first pin X1, the second pin X2, the third pin X3 and the fourth pin X4 are high accordingly. Thus, the connection state indicator 151 and the operating state indicator 153 are off. When the NIC microchip 111 does establish a connection with the LAN, the connection state pin LED2 outputs the low voltage signal (e.g., logical 0), so the first pin X1 and the third pin X3 are enabled to low. Hence, the connection state indicator 151 is powered on. When the NIC microchip 111 is communicating with the LAN at a 10M/100M link speed, the first operating pin LED0 outputs the pulse signal, the second pin X2 and the fourth pin X4 output alternating high and low voltage signals, making the operating state indicator 153 blink or flash. When the NIC microchip 111 is communicating with the LAN using the 1000M link speed, the second operating pin LED1 outputs the pulse signal, the second pin X2 and the fourth pin X4 output alternating high and low voltage signals, thereby, the operating state indicator 153 blinks or flashes.

In summary, in the indicator light circuit of this embodiment of the disclosure, the connection state indicator 151 and the operating state indicator 153 are positioned on the keyboard 13, therefore, the NIC microchip 111 can output different command signals to control and change the connection state indicator 151 and the operating state indicator 153 through the female connector 113 and the male connector 131. Thus, users can easily view, inform and monitor as to the status of the network by identifying the connection state indicator 151 and the operating state indicator 153.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An indicator light circuit, comprising:
a network interface card (NIC) microchip for transmitting data;
a female connector electrically connected to the NIC microchip;
a male connector in electronic communication with the female connector to exchange data;
a connection state indicator electrically connected to the male connector; and
an operating state indicator electrically connected to the male connector, wherein the connection state indicator and the operating state indicator are positioned on a keyboard, when the NIC microchip does establish connection with a communication network, the NIC microchip outputs a first command signal to the connection state indicator through the female connector and the male connector, the connection state indicator is powered on; when the NIC microchip starts communication with the communication network, the NIC microchip outputs a second command signal to the operating state indicator through the female connector and the male connector, the operating state indicator is powered on.

2. The indicator light circuit as claimed in claim 1, further comprising a voltage converting circuit, wherein the voltage converting circuit is electrically connected to the connection state indicator and the operating state indicator, and provides corresponding operating voltages for the connection state indicator and the operating state indicator.

3. The indicator light circuit as claimed in claim 2, wherein the NIC microchip comprises a connection state pin, the female connector comprises a first pin electrically connected to the connection state pin, and the male connector comprises a third pin electrically connected to the first pin, the connection state indicator is electrically connected between the third pin and the voltage converting circuit, when the NIC microchip does establish connection with the communication network, the connection state pin outputs a low voltage signal to enable the first pin and the third pin to low voltage, and the connection state indicator is powered on.

4. The indicator light circuit as claimed in claim 3, wherein the NIC microchip further comprises a first operating state pin, the female connector further comprises a second pin connected to the first operating state pin, and the male connector further comprises a fourth pin electrically connected to the second pin, the operating state indicator is electrically connected between the fourth pin and the voltage converting circuit, when the NIC microchip is communicating with the communication network at a 10M/100M link speed, the first operating pin outputs a pulse signal, the second pin and the fourth pin output alternating high and low voltage signals to make the operating state indicator to flash.

5. The indicator light circuit as claimed in claim 4, wherein the NIC microchip further comprises a second operating state pin electrically connected to the second pin of the female connector, when the NIC microchip is communicating with the communication network using the 1000M link speed, the second operating pin outputs the pulse signal to the second pin and the fourth pin, and the second pin and the fourth pin output alternating high and low voltage signals to enable the operating state indicator to flash.

6. The indicator light circuit as claimed in claim 4, further comprising a first diode and a second diode, wherein the second pin of the female connector is electrically connected to the anodes of the first diode and the second diode, the cathode of the first diode is electrically connected to the first operating state pin of the NIC microchip, the cathode of the second diode is electrically connected to the second operating state pin, the third pin of the male connector electrically connects the cathode of the connection state indicator, the fourth pin of the male connector is electrically connected to the cathode of the operating state indicator, the first diode and the second diode are capable of respectively preventing noise of the first operating state pin and the second operating state pin from interfering with the operating state indicator.

7. The indicator light circuit as claimed in claim 6, wherein the female connector is a personal system 2 (PS/2) female connector, the male connector is a PS/2 male connector, the first diode and the second diode are isolation diodes, the connection state indicator and the operating state indicator are light emitting diodes.

8. The indicator light circuit as claimed in claim 1, wherein the female connector comprises a power pin, the male connector comprises a power pin electrically connected to the power pin of the female pin, the power pin of the female connector is electrically connected to a power supply, the power pin of the male connector is powered by the power supply through the power pin of the male connector, and is electrically connected to the voltage converting circuit.

9. The indicator light circuit as claimed in claim 8, wherein the voltage converting circuit is a voltage dividing circuit and comprises a first voltage dividing resistor and a second voltage dividing resistor electrically connected to the first voltage dividing resistor in series, the power pin of the male connector is electrically connected to the first voltage dividing resistor, the second voltage dividing resistor is electrically connected to ground.

10. The indicator light circuit as claimed in claim 9, further comprising a first current limiting resistor and a second current limiting resistor, wherein one end of the first current limiting resistor is electrically connected to the connection state indicator, the other end of the first current limiting resistor is electrically connected between the first voltage dividing resistor and the second voltage dividing resistor to provide over-current protection for the connection state indicator; one end of the second current limiting resistor electrically connects to the operating state indicator, the other end of the second current limiting resistor electrically connects between the first voltage dividing resistor and the second voltage dividing resistor to protect the operating state indicator from experiencing over-current.

11. An electronic device, comprising:
a network host comprising:
a network interface card (NIC) microchip for communicating and transmitting data between the network host and a communication network; and
a female connector electrically connected to the NIC microchip;
a keyboard in electronic communication with the network host, the keyboard comprising:
a male connector in electronic communication with the female connector to carry out and establish communication between the network host and the keyboard;
a connection state indicator electrically connected to the male connector; and
an operating state indicator electrically connected to the male connector, wherein the connection state indicator and the operating state indicator are positioned on a keyboard, when the NIC microchip establishes connection with the communication network, the NIC microchip provides a first command signal to the connection state indicator through the female connector and the male connector, the connection state indicator is activated; when the NIC microchip starts to communicate with the communication network according to predetermined link speeds, the NIC microchip provides a second command signal to the operating state indicator through the female connector and the male connector, the operating state indicator is powered on.

12. The electronic device as claimed in claim 11, further comprising a voltage converting circuit, wherein the voltage converting circuit is electrically connected to the connection state indicator and the operating state indicator, and provides corresponding operating voltages for the connection state indicator and the operating state indicator.

13. The electronic device as claimed in claim 12, wherein the NIC microchip comprises a connection state pin, the female connector comprises a first pin electrically connected to the connection state pin, and the male connector comprises a third pin electrically connected to the first pin, the connection state indicator is electrically connected between the third pin and the voltage converting circuit, when the NIC microchip establishes connection with the communication network, the connection state pin outputs a low voltage signal, the first pin and the third pin are enabled to low, and the connection state indicator is powered on.

14. The electronic device as claimed in claim 13, wherein the NIC microchip further comprises a first operating state pin, the female connector further comprises a second pin electrically connected to the first operating state pin, and the male connector further comprises a fourth pin electrically connected to the second pin, the operating state indicator is electrically connected between the fourth pin and the voltage converting circuit, when the NIC microchip is communicating with the communication network using a 10M/100M link speed, the first operating pin outputs a pulse signal, the second pin and the fourth pin output alternating high and low voltage signals to make the operating state indicator to flash.

15. The electronic device as claimed in claim 14, wherein the NIC microchip further comprises a second operating state pin electrically connected to the second pin of the female connector, when the NIC microchip is communicating with the communication network using the 1000M link speed, the second operating pin outputs the pulse signal to the second pin and the fourth pin, and the second pin and the fourth pin output alternating high and low voltage signals to enable the operating state indicator to flash.

16. The electronic device as claimed in claim 14, further comprising a first diode and a second diode, wherein the second pin of the female connector is electrically connected to the anodes of the first diode and the second diode, the cathode of the first diode is electrically connected to the first operating state pin of the NIC microchip, the cathode of the second diode is electrically connected to the second operating state pin, the third pin of the male connector electrically connects the cathode of the connection state indicator, the fourth pin of the male connector is electrically connected to the cathode of the operating state indicator, and the first diode and the second diode are configured for respectively preventing noise of the first operating state pin and the second operating state pin from interfering with the operating state indicator.

17. The electronic device as claimed in claim 16, wherein the female connector is a personal system 2 (PS/2) female connector, the male connector is a PS/2 male connector, the first diode and the second diode are isolation diodes, the connection state indicator and the operating state indicator are light emitting diodes.

18. The electronic device as claimed in claim 11, wherein the female connector comprises a power pin, the male connector comprises a power pin electrically connected to the power pin of the female pin, the power pin of the female connector is electrically connected to a power supply, the power pin of the male connector is powered by the power supply through the power pin of the male connector, and is electrically connected to the voltage converting circuit.

19. The electronic device as claimed in claim 18, wherein the voltage converting circuit is a voltage dividing circuit and comprises a first voltage dividing resistor and a second voltage dividing resistor electrically connected to the first voltage dividing resistor in series, the power pin of the male connector is electrically connected to the first voltage dividing resistor, the second voltage dividing resistor is electrically connected to ground.

20. The electronic device as claimed in claim 19, further comprising a first current limiting resistor and a second current limiting resistor, wherein one end of the first current limiting resistor is electrically connected to the connection state indicator, the other end of the first current limiting resistor is electrically connected between the first voltage dividing resistor and the second voltage dividing resistor to provide over-current protection for the connection state indicator, and one end of the second current limiting resistor is electrically connected to the operating state indicator, the other end of the second current limiting resistor is electrically connected between the first voltage dividing resistor and the second voltage dividing resistor.
